(19) United States
(12) Patent Application Publication
(10) Pub. No.: US 2018/0191029 A1
(43) Pub. Date: Jul. 5, 2018

(54) GEL ELECTROLYTE AND APPLICATIONS THEREOF

(71) Applicant: INDUSTRIAL TECHNOLOGY RESEARCH INSTITUTE, Hsinchu (TW)

(72) Inventors: Chih-Jen Yang, Taoyuan City (TW); Yu-Ruei Kung, New Taipei City (TW); Li-Ting Huang, New Taipei City (TW); Chyi-Ming Leu, Hsinchu County (TW)

(73) Assignee: INDUSTRIAL TECHNOLOGY RESEARCH INSTITUTE, Hsinchu (TW)

(21) Appl. No.: 15/854,302

(22) Filed: Dec. 26, 2017

(30) Foreign Application Priority Data
Dec. 30, 2016 (TW) 105144212

(51) Int. Cl. H01M 10/0565; H01M 10/052

(52) U.S. Cl. CPC H01M 10/0565; H01M 2300/0082; H01M 10/052

(57) ABSTRACT

A gel electrolyte and applications thereof are provided. The composition of the gel electrolyte includes an organic base and hydrogen ion exchanged inorganic nano-platelets dispersed in the organic base. The hydrogen ion exchanged inorganic nano-platelets have a size of 20 nm-80 nm. The hydrogen ion exchanged inorganic nano-platelets are chemically bonded to each other via Si—O—Si bonding. A solid content of the gel electrolyte is 1-10 wt %.

This application claims the benefit of Taiwan application Serial No. 105144212, filed Dec. 30, 2016, the subject matter of which is incorporated herein by reference.

### TECHNICAL FIELD

The present disclosure relates to a gel electrolyte and applications thereof.

### BACKGROUND

Lithium ion batteries have properties of high energy density, having no memory effects and slow charge loss when not in use, and thus lithium ion batteries are commonly seen in commercial electronics fields and are one of the most popular rechargeable battery types used in portable electronic devices.

Currently, the electrolytes of the liquid lithium ion batteries used in commercial products are liquids and have poisonous organic solvent(s), which are harmful to human bodies, and dangers of liquid leakages and explosions may occur in use. Therefore, the developments of non-solvent type electrolytes or electrolytes which only require minimum amount(s) of solvent(s) have been the goal in all fields.

### SUMMARY

The present disclosure relates to a gel electrolyte and applications thereof.

According to one embodiment of the present disclosure, a gel electrolyte is provided. The gel electrolyte includes an organic base and hydrogen ion exchanged inorganic nano-platelets. The hydrogen ion exchanged inorganic nano-platelets have a size of 20 nm-80 nm, the hydrogen ion exchanged inorganic nano-platelets are chemically bonded to each other via silicon-oxygen-silicon (Si—O—Si) bonding, and a solid content of the gel electrolyte is 1-10 wt %.

According to another embodiment of the present disclosure, an electrochromic device is provided. The electrochromic device includes a first electrode, a second electrode, an above-mentioned gel electrolyte and an electrochromic material. The gel electrolyte is disposed between the first electrode and the second electrode, and the electrochromic material is mixed in the gel electrolyte.

According to a further embodiment, a lithium battery is provided. The lithium battery includes an anode, a cathode, a separator membrane, and an above-mentioned gel electrolyte. The separator membrane is located between the anode and the cathode for defining a holding region, and the gel electrolyte is located in the holding region.

The following description is made with reference to the accompanying drawings and embodiments.

### BRIEF DESCRIPTION OF THE DRAWINGS

FIG. 1 shows a schematic drawing of the gel structure of a gel electrolyte according to an embodiment of the present disclosure;

FIG. 2 shows a schematic drawing of an electrochromic device according to an embodiment of the present disclosure; and

FIG. 3 shows a schematic drawing of a lithium battery according to an embodiment of the present disclosure.

### DETAILED DESCRIPTION

In the embodiments of the present disclosure, the gel electrolyte has a relatively low solid content of 1-10 wt % and a relatively high organic content, and after it is poured into a carrier, a simple heating step can turn it into a gel state, such that the gel electrolyte can have excellent electrical conductivity as well as excellent processing characteristics. Details of embodiments of the present disclosure are described hereinafter with accompanying drawings. Specific structures and compositions disclosed in the embodiments are for examples and for explaining the disclosure only and are not to be construed as limitations. A person having ordinary skill in the art may modify or change corresponding structures and compositions of the embodiments according to actual applications.

According to the embodiments of the present disclosure, a gel electrolyte is provided hereinafter. According to the embodiments of the present disclosure, the gel electrolyte can be used for making electrochromic devices and lithium batteries.

According to the embodiments of the present disclosure, the gel electrolyte includes an organic base and hydrogen ion exchanged inorganic nano-platelets. The hydrogen ion exchanged inorganic nano-platelets have a size of 20 nm-80 nm, the hydrogen ion exchanged inorganic nano-platelets are chemically bonded to each other via silicon-oxygen-silicon (Si—O—Si) bonding, and a solid content of the gel electrolyte is 1-10 wt %.

In some embodiments, the solid content of the gel electrolyte is 1-5 wt %.

In some embodiments, the organic base may be selected from the group consisting of ethylene carbonate (EC), propyl acetate (PA), diethyl carbonate (DEC), dimethyl carbonate (DMC), ethylmethyl carbonate (EMC), γ-butyrolactone (GBL) and propylene carbonate (PC).

In some embodiments, the hydrogen ion exchanged inorganic nano-platelets are in an amount of such as 1-10 wt % of the gel electrolyte. In some embodiments, the hydrogen ion exchanged inorganic nano-platelets are in an amount of such as 1-5 wt % of the gel electrolyte. For example, when the organic base of the gel electrolyte is composed of organic solvent(s), such as γ-butyrolactone (GBL) or a combination of γ-butyrolactone (GBL) and propylene carbonate (PC), then the weight percentage of the hydrogen ion exchanged inorganic nano-platelets in the gel electrolyte is substantially the same with the solid content of the gel electrolyte.

In some embodiments, the gel electrolyte may further include an organic ammonium salt or an inorganic lithium salt. In the embodiment, the organic ammonium salt or the inorganic lithium salt may have a concentration of 0.01M-3.0M.

In some embodiments, the organic ammonium salt may be selected from the group consisting of tetraalkyl ammonium bromate, tetraalkyl ammonium perchlorate, and tetraalkyl ammonium fluoroborate. When the organic ammonium salt includes two or more than two of the above-mentioned compounds, the carbon numbers of alkyl groups in each of the compounds may be the same or different.

In some embodiments, the inorganic lithium salt is selected from the group consisting of LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃), LiSCN , LiN(SO₂CF₃)₂, LiO₃SCF₂CF₃, LiC₆F₅SO₃, LiO₂CCF₃, LiSO₃F, LiB(C₆H₅) and LiCF₃SO₃.

The hydrogen ion exchanged inorganic nano-platelets used in the present disclosure may be natural nano-clay or synthetic nano-clay. It is to be noted that when the size of the hydrogen ion exchanged inorganic nano-platelets is larger than 80 nm, the light transmittance is influenced resulting in formations of opaque solutions. In one embodiment, the hydrogen ion exchanged inorganic nano-platelets may be day platelets, and an aspect ratio of the clay platelets is not less than 10, preferably in the range of about 20-100.

In some embodiments, a material of the hydrogen ion exchanged inorganic nano-platelets may include acidified nano-clay, for example, the material of the hydrogen ion exchanged inorganic nano-platelets may be selected from the group consisting of hydrogen ion exchanged smectite clay, vermiculite, halloysite, sericite, mica, synthetic mica, synthetic layered double hydroxide (LDH), and synthetic smectite day.

In some embodiments, the smectite day may include montmorillonite, saponite, beidellite, nontronite, hectorite, stevensite, or any combination thereof.

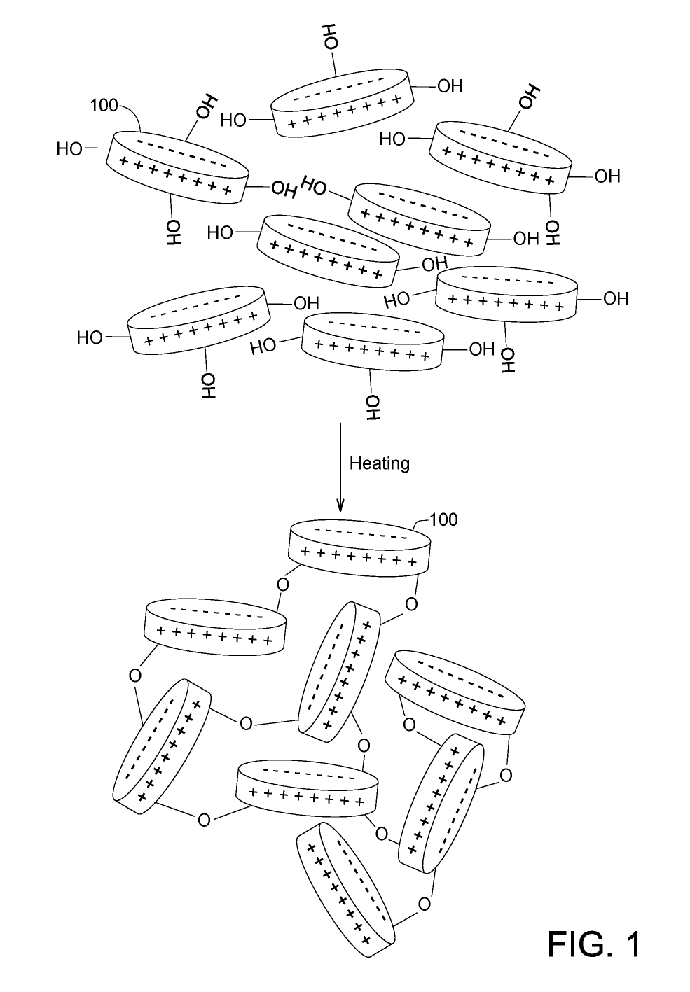

FIG. 1 shows a schematic drawing of the gel structure of a gel electrolyte according to an embodiment of the present disclosure. In the following embodiment, γ-butyrolactone (GBL) is used as the organic base, acidified nano-day is used as the hydrogen ion exchanged inorganic nano-platelets. γ-butyrolactone (GBL) can be hydrolyzed to undergo a reversible ring-opening reaction, as shown in the following formula (I):

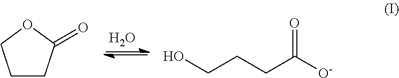

After γ-butyrolactone (GBL) undergoes the ring-opening reaction and has an open-ring structure, the charges it carries will interact with the charges of hydrogen ion exchanged inorganic nano-platelets (acidified nano-clay) 100, facilitating the arrangement of a “House of Cards” stack, as shown in FIG. 1. The acidified surfaces of the hydrogen ion exchanged inorganic nano-platelets 100 form Si—OH groups, and after the structure of the gel electrolyte is heated, the Si—OH groups on the surfaces of the hydrogen ion exchanged inorganic nano-platelets 100 form stable Si—O—Si bonding, turning the “House of Cards” stack of the hydrogen ion exchanged inorganic nano-platelets (acidified nano-clay) 100 into an irreversible network structure, such that the liquid state of the overall structure is turned into a gel state, and it stays at the gel state permanently. Therefore, the organic solvent content of the gel electrolyte can be relatively high, which is far higher than the organic solvent content, e.g. 70-80 wt %, of any currently known polymer gel electrolyte products.

Traditionally, solid state electrolytes and gel state electrolytes are used. The solid state electrolyte is free from the danger of liquid leakages, however, while it is free of solvent, the electrical conductivity of ions is poor (<10⁻⁴ S/cm). The polymer gel state electrolyte has solvent(s) and thus has better electrical conductivity than that of a solid state electrolyte; however, 20-30 wt % of polymer is required to be added therein in order to achieve a gel state, leaving a solvent content of only 70-80 wt %, and thus the gel state structure has a higher viscosity increasing the processing difficulties. On the contrary, according to the embodiments of the present disclosure, the gel electrolyte has a relatively low solid content of 1-10 wt % and a relatively high organic content of 90-99 wt %, and after it is poured into a carrier, a simple heating step can turn it into a gel state, such that the gel electrolyte can have excellent electrical conductivity as well as excellent processing characteristics.

In some embodiments, for example, an inorganic nano-material (e.g. inorganic nano-day) is placed in water, stirred and ultrasonic vibrated to be fully dispersed, then acidified by adding sulfuric acid, and then an ion-exchange process is performed by using anion/cation mixed resin to obtain a deionized inorganic nano-material (inorganic nano-clay) aqueous solution. After the ion-exchange process is performed, the inorganic nano-material in the aqueous dispersion solution is fully exchanged into H ion-form inorganic nano-material, i.e. hydrogen ion exchanged inorganic nano-platelets. Next, the aqueous dispersion solution of the hydrogen ion exchanged inorganic nano-platelets is added into an organic solvent (organic base) to be uniformly mixed, and water is removed by such as vacuum decompression concentration to obtain a liquid state precursor of the gel electrolyte. After the liquid state precursor of the gel electrolyte is heated at 40-100° C., the gel electrolyte is formed.

Further explanation is provided with the following examples. Compositions of the gel electrolytes of some embodiments are listed for showing the properties of the gel electrolytes prepared according to the embodiments of the disclosure. However, the following examples are for purposes of describing particular embodiments only, and are not intended to be limiting.

The manufacturing process of gel electrolytes of embodiments 1-5 and an organic dispersion solution of a comparative embodiment are as follows:

30 g of a day (Laponite RD, particle size of 20 nm×20 nm×1 nm) was dispersed in 970 g of deionized water to form 1000 g of 3 wt % of a clay aqueous dispersion solution. Next, 300 g of an H-form cation ion-exchange resin (Dowex H form) and 300 g of an OH-form anion ion-exchange resin (Dowex OH form) were added to the aqueous dispersion solution to perform an ion-exchange process. After filtering, 960 g of 1.8 wt % of an H ion-form clay (i.e. hydrogen ion exchanged inorganic nano-platelets) aqueous dispersion solution was obtained. Then, an organic solvent was added to be thoroughly mixed with the H ion-form clay aqueous dispersion solution. Next, water was removed by vacuum decompression concentration and an H ion-form clay organic dispersion solution was obtained. Next, the H ion-form clay organic dispersion solution is heated, and whether or not it forms a gel state is observed.

The compositions and heating conditions of the gel electrolytes of embodiments 1-5 and the organic dispersion solutions of comparative embodiments 1-2 are listed in table 1. DMac in table 1 is N,N-dimethyl acetamide.

TABLE 1

| | | | Forming a | Heating |
|---|---|---|---|---|
| | Laponite | Organic | gel state or not | time |
| | RD (wt %) | solvent | (heating at 60° C.) | (hr) |
| Embodiment 1 | 1.93 | GBL | Yes | 12 |
| Embodiment 2 | 1.93 | GBL + PC | Yes | 12 |
| Embodiment 3 | 2.08 | GBL | Yes | 2 |
| Embodiment 4 | 3.01 | GBL | Yes | 1 |
| Embodiment 5 | 4.88 | GBL | Yes | 0.5 |
| Comparative | 3.05 | DMAc | No | 5 |
| embodiment 1 | | | | |
| Comparative | 4.79 | DMAc | No | 5 |
| embodiment 2 | | | | |

According to the results in table 1, the compositions of all of the embodiments can form gel states after performing a heating process thereon, and the compositions of the comparative embodiments cannot form get states even after being heated for a long time.

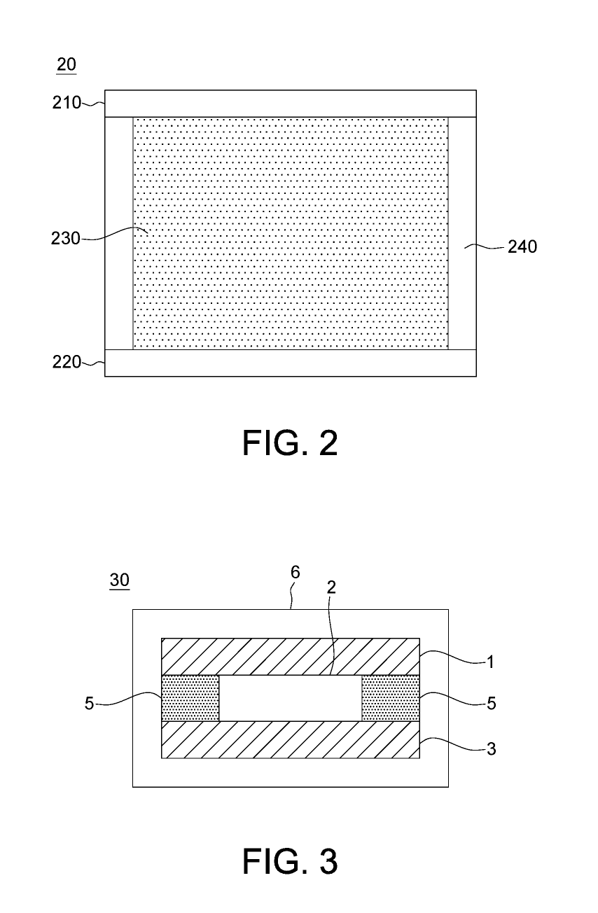

FIG. 2 shows a schematic drawing of an electrochromic device according to an embodiment of the present disclosure.

As shown in FIG. 2, the electrochromic device 20 includes a first electrode 210, a second electrode 220, a gel electrolyte 230 and an electrochromic material. The gel electrolyte is disposed between the first electrode 210 and the second electrode 220. The electrochromic material is mixed in the gel electrolyte 230. The composition of the gel electrolyte is as aforementioned.

As shown in FIG. 2, the electrochromic device 20 may further include a sealant 240, and a distance between the first electrode 210 and the second electrode 220 is provided by the sealant 240 for sealing the gel electrolyte 230 therein.

In the embodiment, the electrochromic material includes an anode electrochromic material and a cathode electrochromic material.

In some embodiments, the cathode electrochromic material may be, for example, selected from the group consisting of

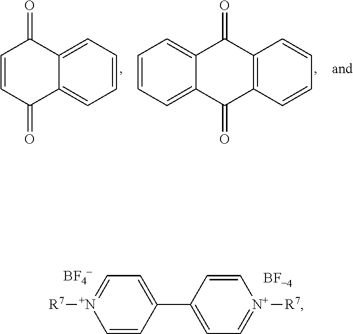

wherein R⁷ is C1-C10 alkyl.

In some embodiments, the anode electrochromic material may be, for example, selected from the group consisting of triarylamine, para-phenylenediamine, tetra aryl benzidine derivative,

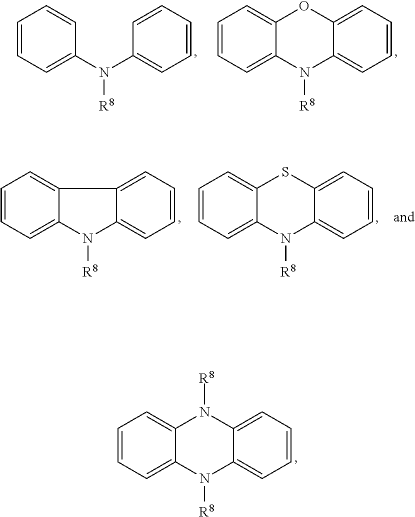

wherein R⁸ is H or alkyl.

Further explanation is provided with the following examples. A manufacturing method of an electrochromic device 20 of an embodiment is described hereinafter. However, the following example is for purposes of describing particular embodiment only, and is not intended to be limiting.

First, 0.1595 g of phenothiazine (PSN) (anode electrochromic material) and 0.2113 g of heptyl viologen (HV(BF₄)₂) (cathode electrochromic material) were dissolved in 12 g of an aforementioned gel electrolyte, which has a solid content of 2.18 wt %, and stirred until fully dissolved, thus a liquid state precursor of a gel electrolyte was formed. Tetrabutylammonium tetrafluoroborate (TBABF₄) and propylene carbonate (PC) may be further added into the liquid state precursor of the gel electrolyte.

Next, a 1 micron syringe filter was prepared for filtering. Next, two pieces of ITO conductive glass with suitable sizes were cut, the distance between the two ITO conductive glass was fixed by a sealant, and the aforementioned as-made liquid state precursor of the gel electrolyte was poured into the spacing between the two ITO conductive glass and sealed. Next, after standing for one hour, the liquid state precursor became sticky and started to turn gel-like. After standing for three hours, the liquid state precursor formed a static gel, and an electrochromic device with a gel electrolyte was obtained. A heating process may be performed on the liquid state precursor as well for the gel electrolyte to be formed.

Finally, 1.28V of power is provided from a DC current supply to the device for tests. A color change of the gel electrolyte from transparent to bluish-black is observed, and the color change is reversible.

FIG. 3 shows a schematic drawing of a lithium battery according to an embodiment of the present disclosure. The lithium battery 30 includes an anode 1, a cathode 3, a separator membrane 5 and an above-mentioned gel electrolyte. The separator membrane 5 is located between the anode 1 and the cathode 3 for defining a holding region 2, and the gel electrolyte is located in the holding region 2. The composition of the gel electrolyte is as aforementioned.

As shown in FIG. 3, the lithium battery 30 may further include an encapsulation structure 6 for covering the anode 1, the cathode 3, and separator membrane 5 and the gel electrolyte in the holding region 2.

In some embodiments, the anode 1 may include a carbon-containing compound and lithium alloy. The carbon-containing compound may be carbon powders, graphite, carbon fibers, carbon nanotubes, or any combination thereof. In an embodiment of the present disclosure, the carbon-containing compound is carbon powders, with a particle size of about 5 μm to 30 μm. The lithium alloy may be LiAl, LiZn, Li₃Bi, Li₃Cd, Li₃Sb, Li₄Si, Li_{4.4}Pb, Li_{4.4}Sn, LiC₆, Li₃FeN₂, Li_{2.6}Co_{0.4}N, Li_{2.6}Cu_{0.4}N, or any combination thereof. In addition to the above-mentioned two materials, the anode 1 may further include a metal oxide, e.g. SnO, SnO₂, GeO, GeO₂, In₂O, In₂O₃, PbO, PbO₂, Pb₂O₃, Pb₃O₄, Ag₂O, AgO, Ag₂O₃, Sb₂O₃, Sb₂O₄, Sb₂O₅, SiO, ZnO, CoO, NiO, FeO, or any combination thereof.

In some embodiments, the composition of the cathode 3 may be lithium mixed metal oxide, e.g. LiMnO₂, LiMn₂O₄, LiCoO₂, Li₂Cr₂O₇, Li₂CrO₄, LiNiO₂, LiFeO₂, LiNiₓCo₁₋ₓO₂, LiFePO₄, LiMn_{0.5}Ni_{0.5}O₂, LiMn_{1/3}Co_{1/3}Ni_{1/3}O₂, LiMc_{0.5}Mn_{1.5}O₄, or any combination thereof, wherein 0<x<1, and Mc is bivalent metal.

In some embodiments, the above-mentioned anode 1 and/or cathode 3 may further include a polymer binder for increasing the mechanical properties of the electrodes. A suitable polymer binder may be polyvinylidene fluoride (PVDF), styrene-butadiene rubber (SBR), polyamide, melamine resin, or any combination thereof.

In some embodiments, the separator membrane 5 is an insulating material, for example, PE, PP or a multilayered structure, e.g. PE/PP/PE, of the above material.

In some embodiments, the composition of the gel electrolyte is as aforementioned. For example, the gel electrolyte may include the aforementioned organic base, the aforementioned hydrogen ion exchanged inorganic nano-platelets, the aforementioned organic ammonium salt and/or the aforementioned inorganic lithium salt, and etc., and the description of which is omitted here.

Further explanation is provided with the following examples. A lithium battery 30 and a manufacturing method thereof according to an embodiment are described hereinafter. However, the following example is for purposes of describing particular embodiment only, and is not intended to be limiting.

90 parts by weight of LiCoO₂, 5 parts by weight of PVDF and 5 parts by weight of acetylene black (conductive powders) were dispersed in NMP, and the as-formed slurry was coated on an aluminum foil, dried, compressed and cut for forming a cathode. Meanwhile, 95 parts by weight of graphite and 5 parts by weight of PVDF were dispersed in NMP, and the as-formed slurry was coated on an aluminum foil, dried, compressed and cut for forming an anode.

Next, 1M of lithium salt LiPF₆ is added into 12.0 g of an aforementioned gel electrolyte, which has a solid content of 2.18 wt %, for forming a liquid state precursor of the gel electrolyte.

Next, a separator membrane made of PP is used for separating the anode from the cathode, and the above-mentioned liquid state precursor of the gel electrolyte is added into the holding region between the anode and the cathode. Finally, an encapsulation structure is used for sealing the above structure. A heating process may be performed on the liquid state precursor to turn it into the gel electrolyte.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A gel electrolyte, comprising:
an organic base; and
hydrogen ion exchanged inorganic nano-platelets dispersed in the organic base, wherein the hydrogen ion exchanged inorganic nano-platelets have a size of 20 nm-80 nm, the hydrogen ion exchanged inorganic nano-platelets are chemically bonded to each other via silicon-oxygen-silicon (Si—O—Si) bonding, and a solid content of the gel electrolyte is 1-10 wt %.

2. The gel electrolyte according to claim 1, wherein the solid content of the gel electrolyte is 1-5 wt %.

3. The gel electrolyte according to claim 1, wherein the organic base is selected from the group consisting of ethylene carbonate (EC), propyl acetate (PA), diethyl carbonate (DEC), dimethyl carbonate (DMC), ethylmethyl carbonate (EMC), γ-butyrolactone (GBL) and propylene carbonate (PC).

4. The gel electrolyte according to claim 1, wherein the gel electrolyte further comprises an organic ammonium salt or an inorganic lithium salt.

5. The gel electrolyte according to claim 4, wherein the organic ammonium salt or the inorganic lithium salt has a concentration of 0.01M-3.0M.

6. The gel electrolyte according to claim 4, wherein the organic ammonium salt is selected from the group consisting of tetraalkyl ammonium bromate, tetraalkyl ammonium perchlorate, and tetraalkyl ammonium fluoroborate.

7. The gel electrolyte according to claim 4, wherein the inorganic lithium salt is selected from the group consisting of LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃), LiSCN , LiN(SO₂CF₃)₂, LiO₃SCF₂CF₃, LiC₆F₅SO₃, LiO₂CCF₃, LiSO₃F, LiB(C₆H₅) and LiCF₃SO₃.

8. The gel electrolyte according to claim 1, wherein a material of the hydrogen ion exchanged inorganic nano-platelets is selected from the group consisting of hydrogen ion exchanged smectite clay, vermiculite, halloysite, sericite, mica, synthetic mica, synthetic layered double hydroxide (LDH), and synthetic smectite clay.

9. The gel electrolyte according to claim 8, wherein the smectite clay comprises montmorillonite, saponite, beidellite, nontronite, hectorite, stevensite, or any combination thereof.

10. An electrochromic device, comprising:
a first electrode and a second electrode;
a gel electrolyte disposed between the first electrode and the second electrode, wherein the gel electrolyte is as recited in claim 1; and
an electrochromic material mixed in the gel electrolyte.

11. The electrochromic device according to claim 10, wherein the solid content of the gel electrolyte is 1-5 wt %.

12. The electrochromic device according to claim 10, wherein the organic base is selected from the group consisting of ethylene carbonate (EC), propyl acetate (PA), diethyl carbonate (DEC), dimethyl carbonate (DMC), ethylmethyl carbonate (EMC), γ-butyrolactone (GBL) and propylene carbonate (PC).

13. The electrochromic device according to claim 12, wherein the electrochromic material comprises an anode electrochromic material and a cathode electrochromic material.

14. The electrochromic device according to claim 12, wherein the cathode electrochromic material is selected from the group consisting of 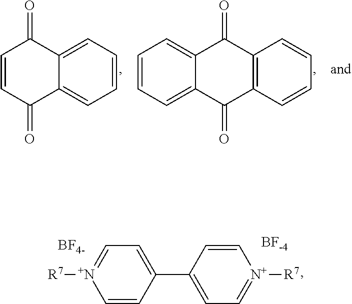
wherein R⁷ is C1-C10 alkyl.

15. The electrochromic device according to claim 12, wherein the anode electrochromic material is selected from the group consisting of triarylamine, para-phenylenediamine, tetra aryl benzidine derivative, 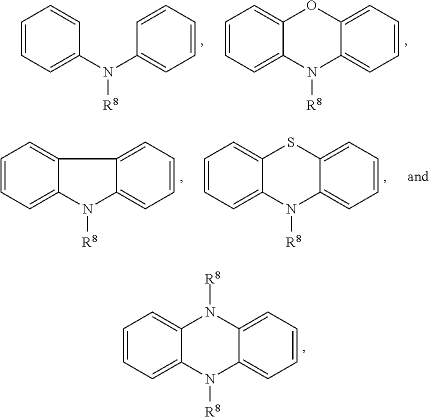
wherein R⁸ is H or alkyl.

16. A lithium battery, comprising:
an anode;
a cathode;
a separator membrane located between the anode and the cathode for defining a holding region; and
a gel electrolyte located in the holding region, wherein the gel electrolyte is as recited in claim 1.
